(19) United States
(12) Patent Application Publication
(10) Pub. No.: US 2003/0072900 A1
(43) Pub. Date: Apr. 17, 2003

(54) Impact energy absorbing structure

(75) Inventors: Osamu Niikura, Yokohama (JP); Shigeo Watanabe, Yokohama (JP); Hiroshi Sakurai, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/268,733

(22) Filed: Oct. 11, 2002

(30) Foreign Application Priority Data
Oct. 12, 2001 (JP) 2001-315186
Mar. 29, 2002 (JP) 2002-095718

(51) Int. Cl. B32B 1/08

(52) U.S. Cl. 428/34.1; 428/36.9

(57) ABSTRACT

An impact energy absorbing structure includes an outer-shell structural member having a hollow portion, and a porous element filling the hollow portion of the outer-shell structural member and capable of collapsing while keeping a reaction force produced by the porous element constant from an early stage of application of a compressive stress. A partition wall having a through opening formed therein is provided in the hollow portion of the outer-shell structural member. The partition wall is located on one side of the porous element, opposite to the other side to which the compressive stress is applied, so as to ensure improved impact energy management and high-response structural crash behavior.

### TECHNICAL FIELD

The present invention relates to an impact energy absorbing structure suitable for automotive vehicles, and particularly to techniques of impact energy management required for efficiently rapidly absorbing impact energy in an impact situation.

### BACKGROUND ART

Impact protection for vehicle occupants has now spread to most categories of vehicle including passenger cars, trucks, buses, and the like. Generally, an automotive vehicle body is formed with an impact energy absorbing structural layout, in order to effectively absorb impact energy when impact load is applied to a vehicle body and consequently to avoid main vehicle body structural elements from being affected by the impact load. In recent years, there are various ways to increase an impact energy absorbing capacity of the impact energy absorbing structure. One technique of increasing the impact energy absorbing capacity is to increase the thickness or material strength of the structural member. Another technique of increasing the energy absorbing capacity is to provide a hollow structural member filled with an energy absorber or energy absorbent material. One such impact energy absorbing structural layout has been disclosed in Japanese Patent Provisional Publication No. 8-164869 (corresponding to U.S. Pat. No. 5,611,568 issued Mar. 18, 1997 to Toshio Masuda). The automotive chassis frame structure disclosed in U.S. Pat. No. 5,611,568, teaches the use of left and right hollow inner side members being approximately parallel to a body centerline and left and right hollow outwardly-slanted auxiliary side members of the chassis frame, each being filled with aluminum foams. Under the action of impact load (compressive load or compressive stress), the aluminum foam is able to absorb impact energy more effectively by collapsing of the aluminum foam in a direction of the line of action of impact load. Such a conventional hollow impact energy absorbing structural layout filled with aluminum foam is simple in construction.

### SUMMARY OF THE INVENTION

However, in the automotive chassis frame structure disclosed in U.S. Pat. No. 5,611,568, each of the inner and outer side members throughout its length is filled with aluminum foam. Thus, there is little likelihood of a remarkable rise in reaction force created by crushing or collapsing of the aluminum foam, until the side members have been largely deformed. Additionally, the side member filled with aluminum foam throughout its length, leads to the problem of an increased gross weight of the chassis frame structure. Also, the material cost of aluminum foam is expensive.

Accordingly, it is an object of the invention to provide an impact energy absorbing structure, which avoids the aforementioned disadvantages.

It is another object of the invention to provide an impact energy absorbing structure, capable of rising a reaction force of a porous element serving as an energy absorber from an early stage when a structural member begins to deform owing to application of compressive load or impact load and also capable of realizing both lightweight and reduced manufacturing costs.

In order to accomplish the aforementioned and other objects of the present invention, an impact energy absorbing structure comprises an outer-shell structural member having a hollow portion, a porous element filling the hollow portion of the outer-shell structural member and capable of collapsing while keeping a reaction force produced by the porous element constant from a time when a compressive stress is applied to the porous element, and a partition wall having a through opening formed therein and provided in the hollow portion of the outer-shell structural member and located on one side of the porous element filling the hollow portion, the one side being opposite to the other side to which the compressive stress is applied.

The other objects and features of this invention will become understood from the following description with reference to the accompanying drawings.

### BRIEF DESCRIPTION OF THE DRAWINGS

FIG. 1A is a perspective view of an automotive-frame front side member to which an impact energy absorbing structural member of the first embodiment is applied.

FIG. 1B is a longitudinal cross-section of the impact energy absorbing structural member (the front side member shown in FIG. 1A), having a porous element (aluminum foam) and a partition wall formed with a through opening.

FIG. 2 is a general perspective view of a vehicle body to which the impact energy absorbing structural member of the embodiment is applied.

FIG. 3 is an explanatory cross-section illustrating the structural crash behavior of the impact energy absorbing structural member (the front side member shown in FIG. 1B), under application of the impact load to the front side member of FIG. 1B.

FIG. 4 is a characteristic diagram illustrating the relationship between an average reaction force and a collapse amount at various partition wall through-opening diameters, that is, φ0, φ10, φ30, φ50, φ70, and φ90, under application of the impact load to the front side member shown in FIG. 1.

FIG. 5 is a characteristic diagram illustrating the relationship between an average reaction force, created when the front side member shown in FIG. 1 is collapsed, and an area ratio of an opening area of the partition wall through opening to a cross-sectional area of a front outer-shell structural member, under application of the impact load to the front side member shown in FIG. 1.

FIG. 6 is an explanatory cross-section illustrating the front-side-member partition wall that the inner peripheral wall surface of the partition-wall through opening is constructed as a frusto-conical tapered through-opening inner peripheral surface.

FIG. 7 is a characteristic diagram illustrating the relationship between an energy absorption power and an inclination angle θ of the frusto-conical tapered through-opening inner peripheral wall surface to the partition wall surface.

FIG. 8 is a longitudinal cross-section of another impact energy absorbing structural member (applicable as a front side member of an automotive frame shown in FIG. 1A), having a porous element (aluminum foam) and first and second partition walls each formed with a through opening.

FIG. 9 is an explanatory cross-section illustrating the structural crash behavior of the impact energy absorbing structural member (the front side member shown in FIG. 8), under application of the impact load to the front side member of FIG. 8.

FIG. 10 is a characteristic diagram illustrating the relationship among an energy absorption amount (or energy absorption power), an area ratio S1/S0 of an opening area S1 of the first partition wall through opening to a cross-sectional area S0 of the porous element (aluminum foam), and an area ratio S2/S1 of an opening area S2 of the second partition wall through opening to opening area S1 of the first partition wall through opening.

FIG. 11 is an explanatory cross-section illustrating the structural crash behavior of an impact energy absorbing structural member somewhat modified from the front side member structure shown in FIG. 8.

FIG. 12 is an explanatory cross-section illustrating a forming process of an outer-shell structural member of an impact energy absorbing structural member of another embodiment of the invention.

FIG. 13 is an explanatory cross-section illustrating a forming process of an outer-shell structural member of an impact energy absorbing structural member of a still further embodiment of the invention.

FIG. 14 is an explanatory view illustrating the relationship between a ratio t′/t₀ of a thickness t′ of the partition wall, which is formed by way of a metal-spinning process shown in FIG. 12, to a thickness t₀ of the outer-shell structural member (or a ratio σ_{y}′/σ_{4 y} of a yield stress σ_{y}′ of the partition wall formed by way of the metal-spinning process to a yield stress σ_{y} of the outer-shell structural member), and an unconfined compressive strain of the impact energy absorbing structural member.

FIG. 15A is an explanatory cross-section of an automotive center pillar to which the impact energy absorbing structural member of the embodiment is applied.

FIG. 15B is an enlarged perspective view of an automotive center pillar reinforcement serving as a partition wall of the impact energy absorbing structural member (the automotive center pillar shown in FIG. 15A).

FIG. 16A is an explanatory cross-section of an automotive side sill to which the impact energy absorbing structural member of the embodiment is applied.

FIG. 16B is an enlarged perspective view of an automotive side sill reinforcement serving as a partition wall of the impact energy absorbing structural member (the automotive side sill shown in FIG. 16A).

### DESCRIPTION OF THE PREFERRED EMBODIMENTS

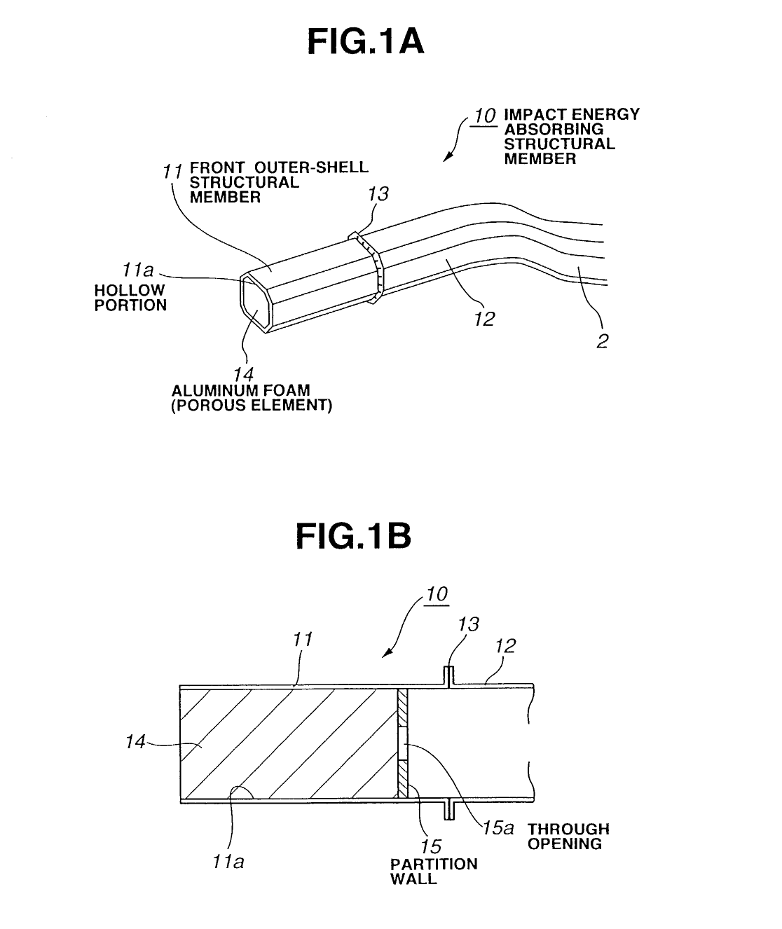

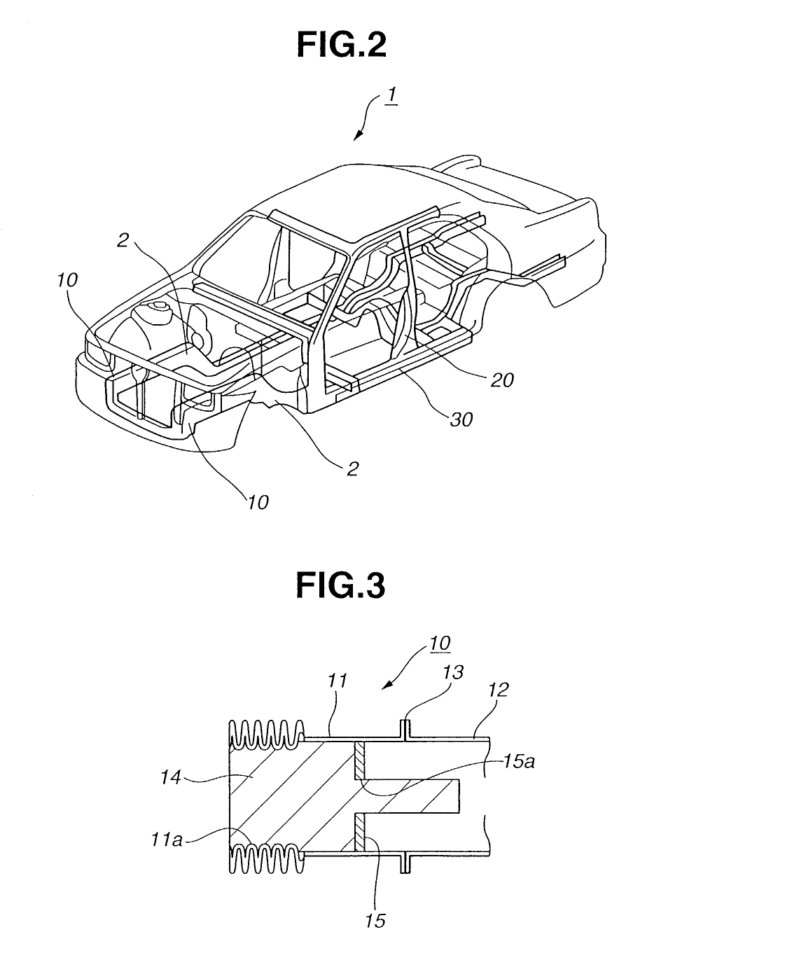

Referring now to the drawings, particularly to FIGS. 1 through 7, the impact energy absorbing structural member of the first embodiment is exemplified in a front side member 10 of an automotive frame. As shown in FIGS. 1A, 1B, and 2, front side member 10 is connected to the front end of a side member extension 2 of an automotive chassis 1, in such a manner as to function as an impact energy absorbing structural member in a frontal impact situation. Front side member 10 is mainly comprised of a front outer-shell structural member 11, a rear outer-shell structural member 12, and a porous element 14 such as metal foam, preferably aluminum foam. Front outer-shell structural member 11 is formed with a hollow portion 11a, whereas rear outer-shell structural member 12 is formed with a hollow portion 12a. Porous element 14 (aluminum foam) fills hollow portion 11a of front outer-shell structural member 11 so that the porous element collapses or crashes while keeping a reaction force produced by the porous element constant from an early stage of application of a compressive stress to the front side member. Rear outer-shell structural member 12 is formed integral with side member extension 2. In the first embodiment, front and rear outer-shell structural members 11 and 12 are integrally connected to each other through a flange 13. In lieu thereof, front and rear outer-shell structural members 11 and 12 may be integrally formed with each other. In front side member 10 (impact energy absorbing structural member) of the first embodiment, a partition wall 15, formed therein with a through opening 15a, is provided in hollow portion 11a of front outer-shell structural member 11 and located on one side (a rear end face in FIG. 1B) of porous element 14 (filling hollow portion 11a) opposite to the other side (a front end face in FIG. 1B) of porous element 14 to which the compressive stress is applied. Partition wall 15 is arranged to be perpendicular to a neutral axis of front outer-shell structural member 11 of front side member 10 or an input axis P of an external force (compressive load or impact load) applied to front outer-shell structural member 11. Although it is not clearly shown in FIGS. 1B and 3, in the front side member (impact energy absorbing structural member) of the first embodiment, a thickness of a portion (hereinafter is referred to as a “first outer-shell portion”) of front outer-shell structural member 11, that is in contact with porous element 14 (aluminum foam), is dimensioned to be relatively thinner than a thickness of a portion (hereinafter is referred to as a “second outer-shell portion”) of the outer-shell structural member, that is out of contact with porous element 14. Rear outer-shell structural member 12 is included in the second outer-shell portion. Alternatively, a material strength of the first outer-shell portion may be set or determined to be relatively weaker than that of the second outer-shell portion such that the first outer-shell portion is easier to collapse or compressively deform than the second outer-shell portion. In a front-end impact situation that the compressive stress is applied to the front-end face of porous element 14 of front side member 10 and thus the porous element collapses, partition wall 15 tends to elastically deform by a load dissipated in the collapsed porous element. In the shown embodiment, an area ratio of an opening area of partition-wall through opening 15a to a cross-sectional area of front outer-shell structural member 11 is dimensioned to be a predetermined area ratio ranging from 0.1 to 0.5 (see the predetermined area-ratio range indicated by the arrow ←→ in FIG. 5). In addition to the above, in the impact energy absorbing structure of the first embodiment, an area of an initial contact portion of porous element 14 (aluminum foam) that is brought into initial contact with respect to partition wall 15 just after application of the compressive load or impact load is dimensioned to be greater than or equal to a gross area of partition-wall through opening 15a.

In the impact energy absorbing structural member (front side member 10) of the first embodiment, as discussed above, porous element 14 (aluminum foam) fills only a first divided portion of front outer-shell structural member hollow portion 11a, which is divided by partition wall 15 and to which the compressive stress is applied. In the front-end impact situation that the compressive stress is applied to the front-end face of porous element 14 of front side member 10, porous element 14 (aluminum foam) tends to crash, collapse or deform in the same direction as a beam-collapse direction of front side member 10. There is an increased tendency for the structural collapse of porous element 14 (aluminum foam) in the same direction as the beam-collapse direction to be effectively induced by way of contact between porous element 14 and partition wall 15 functioning as a support for the rear end face of porous element 14. As compared to the conventional impact energy absorbing structural member as disclosed in U.S. Pat. No. 5,611,568, a filling length of porous element 14 (aluminum foam) of the impact energy absorbing structural member (front side member 10) of the first embodiment is dimensioned to be relatively shorter. Owing to the shorter filling length of porous element 14, a compressive strain tends to easily develop from an early stage of structural collapse or structural deformation. In other words, in the front-end impact situation, a reaction force produced by porous element 14 tends to rise with a high response from the early stage of application of compressive stress to the front end of front side member 10. Additionally, in the first embodiment (see FIGS. 1A, 1B, and 3), through opening 15a is formed in partition wall 15, and therefore the energy absorption amount or energy absorption power (in the beam-collapse direction of front side member 10) tends to decrease in comparison with a front side member not having a partition-wall through opening. However, as can be seen from the cross section of FIG. 3, during impact loading that front outer-shell structural member 11 and porous element 14 (aluminum foam) are collapsing and deforming together, porous element 14 in hollow portion 11a is pressurized and then a part of porous element 14 extrudes from partition-wall through opening 15a toward the internal space of rear outer-shell structural member 12, while cutting or breaking the inner peripheral wall portion of partition-wall through opening 15a. The extrusion of a portion of porous element 14 from partition-wall through opening 15a and breakage of the inner peripheral wall portion of partition-wall through opening 15a contribute to an increase in energy absorption amount or energy absorption power in the beam-collapse direction of front side member 10. That is, the decrease in energy absorption amount, occurring owing to the partition-wall through opening, can be compensated for by the increase in energy absorption amount, arising from the extrusion of a portion of porous element 14 from partition-wall through opening 15a and breakage of the inner peripheral wall portion of partition-wall through opening 15a. As a consequence, front side member 10 having partition wall 15 formed with through opening 15a can provide the same energy absorption ability as the front side member not having the partition-wall through opening. On the other hand, partition-wall through opening 15a contributes to a reduction in total weight of the vehicle frame assembly. In a greater front-end impact situation, collapsing deformation of rear outer-shell structural member 12 is further added to collapsing deformation of both front outer-shell structural member 11 and porous element 14 (aluminum foam), thereby increasing the collapse rate and energy absorption amount. As previously described, in the impact energy absorbing structural member of the first embodiment shown in FIGS. 1A and 1B, the filling length of porous element 14 is dimensioned to be remarkably shorter than that of the conventional frame structure as disclosed in U.S. Pat. No. 5,611,568. This contributes to reduced weight and low manufacturing costs.

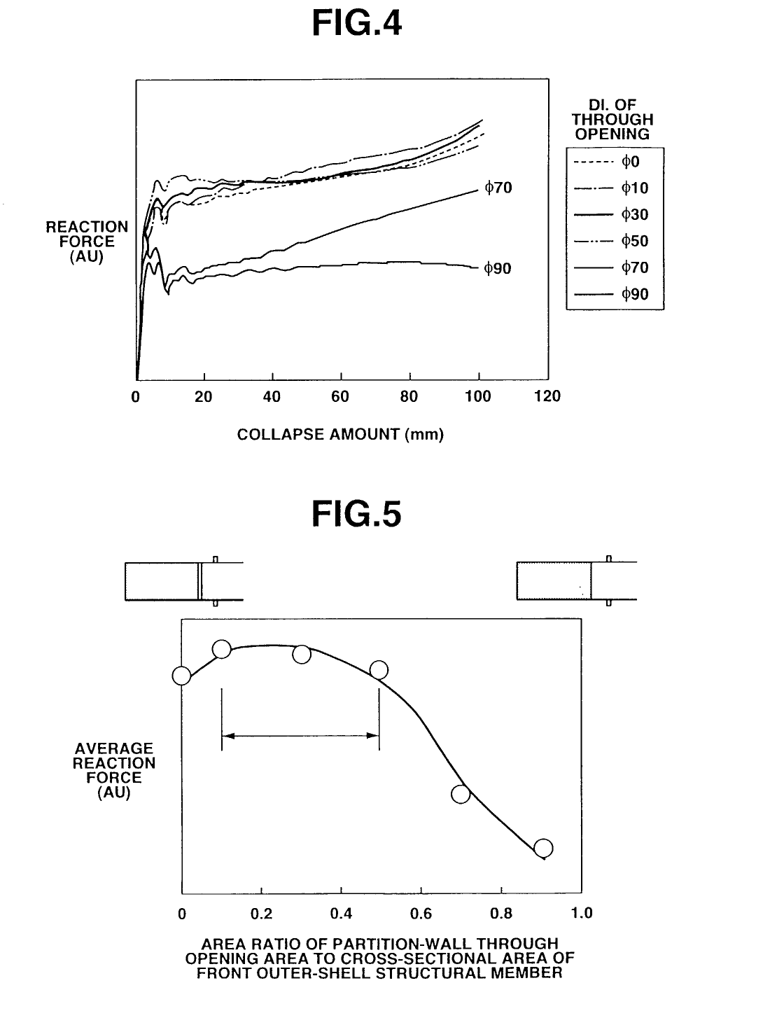

FIG. 4 shows test results illustrating the relationship between the average reaction force produced by front side member 10 and the collapse amount of front side member 10, at six different partition-wall through opening diameters φ0, φ10, φ30, φ50, φ70, and φ90. The test results shown in FIG. 4 are experimentally assured by the inventors of the present invention, under a specified condition where the hollow portion of front outer-shell structural member 11 of front side member 10 is filled with a substantially cylindrical porous element 14 (aluminum foam) having a density of 0.25 g/cm³, an outside diameter of 100 mm, and an entire axial length (a filling length) of 150 mm. As can be seen from the test results of FIG. 4, the reaction versus collapse amount characteristic curves obtained at the partition-wall through opening diameters of φ10 (see the one-dotted line in FIG. 4), φ30 (see the uppermost solid line in FIG. 4), and φ50 (see the two-dotted line in FIG. 4) are similar to that obtained at the partition-wall through opening diameter of φ0 (see the broken line in FIG. 4). A range of the partition-wall through opening diameter ranging from φ10 to φ50 corresponds to a range that a ratio of the partition-wall through opening diameter to the outside diameter (=100 mm) of porous element 14 is less than or equal to 50% (actually, 10% at φ10, 30% at φ30, and 50% at φ50). As appreciated from the reaction versus collapse amount characteristic curves obtained within the range of the partition-wall through opening diameter ranging from φ10 to φ50 similar to that obtained at the partition-wall through opening diameter of φ0, the front side member having partition wall 15 that the ratio of the partition-wall through opening diameter to the outside diameter of porous element 14 is less than or equal to 50% has almost the same energy absorption performance as the front side member having a partition wall that the ratio of the partition-wall through opening diameter to the outside diameter of porous element 14 is 0% (without a through opening). That is, partition wall 15 with the through opening 15a contributes to both reduced weight and improved impact energy management (stable impact resistance, proper energy absorption velocity, rapid energy absorption timing, and energy absorption ability), by way of synergistic effect of the extrusion of a portion of porous element 14 from partition-wall through opening 15a, breakage of the inner peripheral wall portion of partition-wall through opening 15a, and the shorter filling length of porous element 14. In contrast to the above, in case of the partition-wall through opening diameters of φ70 (see the intermediate solid line in FIG. 4) and φ90 (see the lowermost solid line in FIG. 4), a part of porous element 14 (aluminum foam) tends to extrude more than needs. This lowers the energy absorption ability.

FIG. 5 shows test results illustrating the relationship between the average reaction force produced by front side member 10 during the collapsing deformation of front side member 10 and the area ratio of the opening area of partition-wall through opening 15a to the cross-sectional area of front outer-shell structural member 11, sectioned in a plane perpendicular to the neutral axis of the front outer-shell structural member, in other words, input axis P of the external force (compressive load or impact load) applied to front outer-shell structural member 11. The test results shown in FIG. 5 are experimentally assured by the inventors of the present invention, under a specified condition where the hollow portion of front outer-shell structural member 11 of front side member 10 is filled with a substantially cylindrical porous element 14 (aluminum foam) having a density of 0.25 g/cm³ and an entire axial length (a filling length) of 150 mm, and front outer-shell structural member 11 has a characteristic length of 80 mm in cross section, a thickness of the previously-noted first outer-shell portion of front outer-shell structural member 11 filled with porous element 14 is dimensioned to be 1.6 mm, a thickness of the previously-noted second outer-shell portion of front outer-shell structural member 11 not filled with porous element 14 is dimensioned to be 2.0 mm, and the test data are measured at a timing that a collapse ratio of an amount of collapsing deformation of front side member 10 to the filling length of porous element 14 (aluminum foam) reaches 0.6, that is, the amount of collapsing deformation of front side member 10 reaches 60% (=90 mm) of the filling length (=150 mm) of porous element 14 (aluminum foam). As can be seen from the characteristic curve of FIG. 5, the characteristic curve y=f(x) is concave down (in other words, convex up), where the y-axis (axis of ordinates) denotes the average reaction force, whereas the x-axis (axis of abscissas) denotes the area ratio of the opening area of partition wall through opening 15a to the cross-sectional area of front outer-shell structural member 11. As clearly shown in FIG. 5, the characteristic curve, i.e., the function f(x) has a local maximum at a (≈0.2), because of f′(a)=0 and f″(a)<0. From the test results of FIG. 5, it is possible to establish the fact that the magnitude of average reaction force produced by front side member 10 within the predetermined area-ratio range including the local maximum (≈0.2) and extending from 0.1 to 0.5 (see the predetermined area-ratio range indicated by the arrow ←→ in FIG. 5), is greater than or equal to the magnitude of average reaction force produced by a front side member not having a partition-wall through opening.

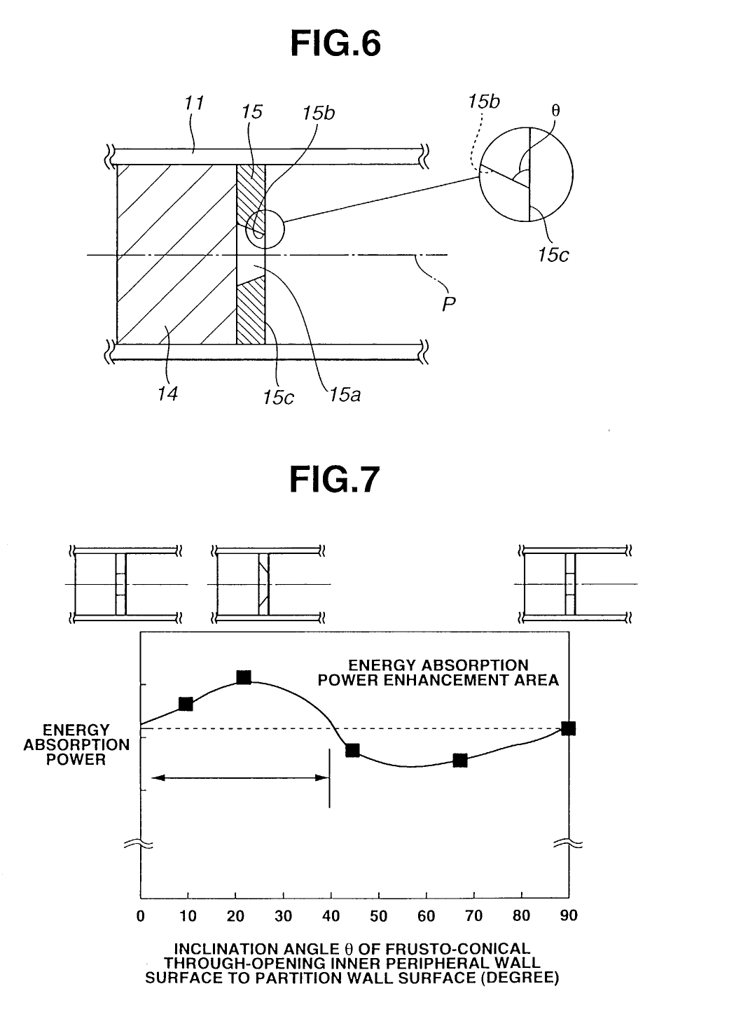

FIG. 6 shows partition wall 15 having a frusto-conical tapered through opening. As can be seen from the longitudinal cross section of FIG. 6, an inner peripheral wall surface 15b of frusto-conical tapered through-opening 15a of partition wall 15 is not parallel to input axis P of the external force (compressive load or impact load) applied to front outer-shell structural member 11. Inner peripheral wall surface 15b of frusto-conical tapered through opening 15a is inclined by a predetermined inclination angle θ with respect to a wall surface 15c (a backface) of partition wall 15 facing apart from porous element 14 filling the hollow portion. FIG. 7 shows test results illustrating the relationship between the energy absorption power during the collapsing deformation of front side member 10 and inclination angle θ. The test results shown in FIG. 7 are experimentally assured by the inventors of the present invention, under a specified condition where the hollow portion of front outer-shell structural member 11 of front side member 10 is filled with a substantially cylindrical porous element 14 (aluminum foam) having a density of 0.25 g/cm³, an outside diameter of 100 mm, and an entire axial length of 150 mm, and a mean diameter of the tapered partition-wall through opening is set to 40 mm, and inclination angle θ varies from 0° to 90°. As appreciated from the characteristic curve of FIG. 7, the energy absorption ability is high substantially at the inclination angle θ of 90° and within an inclination-angle θ range from 0° to 40°. For the reasons set forth above, in tapered partition wall through opening 15b, inclination angle θ is set to approximately 90° or to an angle less than or equal to 40°.

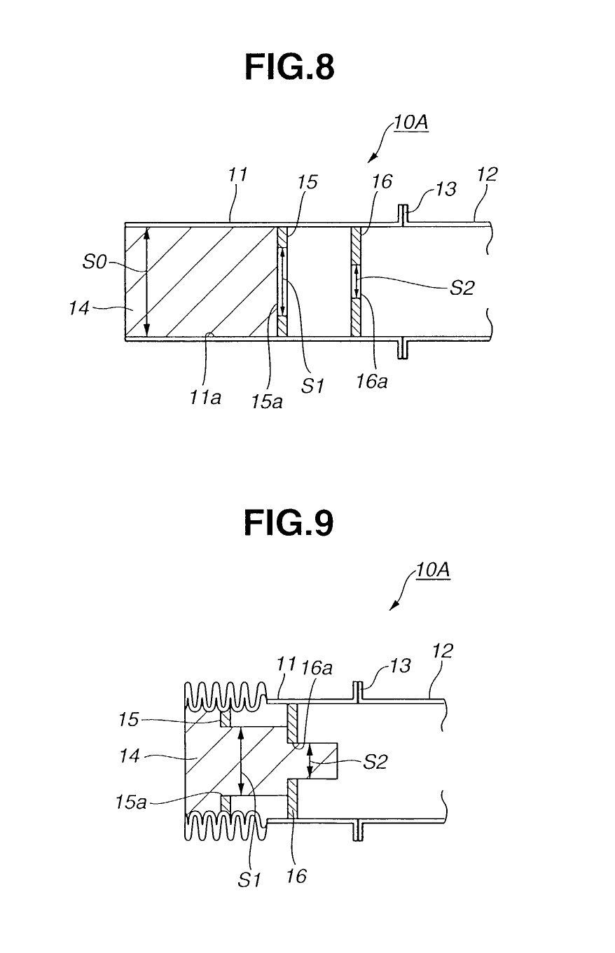

Referring now to FIGS. 8-10, there is shown the impact energy absorbing structural member of the second embodiment, having a cross section somewhat different from that of the first embodiment shown in FIGS. 1A, 1B, and 3. In the same manner as the first embodiment, the impact energy absorbing structural member of the second embodiment is applied to a front side member 10A that is used as an automotive structural element or an automotive structural member (see FIG. 2). The structure of front side member 10A (the impact energy absorbing structural member of the second embodiment) is different from that of front side member 10 (the impact energy absorbing structural member of the first embodiment), in that a second partition wall 16 is further provided in addition to partition wall 15 (a first partition wall). As shown in FIG. 8, second partition wall 16, formed therein with a through opening 16a, is provided in hollow portion 11a of front outer-shell structural member 11 and located on one side of first partition wall 15 (that is, rearward of first partition wall 15) facing apart from the rear end face of porous element 14. First and second partition walls 15 and 16 are arranged in series to each other in the neutral axis of the outer-shell structural member of the front side member or input axis P of the external force (compressive load or impact load) applied to the outer-shell structural member, and extend in the direction perpendicular to the neutral axis of the outer-shell structural member 11.

In the same manner as the first embodiment, in the impact energy absorbing structural member (front side member 10A) of the second embodiment, porous element 14 (aluminum foam) fills only a first divided portion of front outer-shell structural member hollow portion 11a, which is divided by first partition wall 15 and to which the compressive stress is applied. In the front-end impact situation that the compressive stress is applied to the front-end face of porous element 14 of front side member 10A, porous element 14 (aluminum foam) tends to collapse in the same direction as a beam-collapse direction of front side member 10A. There is an increased tendency for the structural collapse of porous element 14 (aluminum foam) in the same direction as the beam-collapse direction to be effectively induced by way of contact between porous element 14 and first partition wall 15 functioning as a support for the rear end face of porous element 14. Owing to a comparatively shorter filling length of porous element 14, a compressive strain tends to easily develop from an early stage of structural collapse, and thus in the front-end impact situation, a reaction force produced by porous element 14 tends to rise with a high response from the early stage of application of compressive stress to the front end of front side member 10A. Additionally, in the second embodiment (see FIGS. 8 and 9), second partition wall 16, formed therein with through opening 16a, is located on the side of first partition wall 15 facing apart from the rear end face of porous element 14. As clearly shown in FIG. 9, during impact loading that front outer-shell structural member 11 and porous element 14 (aluminum foam) are collapsing and deforming together, porous element 14 in hollow portion 11a is pressurized and a part of porous element 14 extrudes from first partition-wall through opening 15a into the internal space defined backward of first partition wall 15, while cutting or breaking the inner peripheral wall portion of first partition-wall through opening 15a. Thereafter, a part of porous element 14 that has extruded from first partition-wall through opening 15a into the internal space, further extrudes from second partition-wall through opening 16a into an internal space defined backward of second partition wall 16. Thus, the decrease in energy absorption amount, occurring owing to the first and second partition-wall through openings, can be compensated for by the increase in energy absorption amount, arising from the extrusion of a portion of porous element 14 from each of first and second partition-wall through openings 15a and 16a and breakage of the inner peripheral wall portion of at least first partition-wall through opening 15a. As a consequence, front side member 10A having first and second partition walls 15 and 16 having respective through openings 15a and 16a can provide the same energy absorption ability as the front side member not having the partition-wall through opening. On the other hand, first and second partition-wall through openings 15a and 16a contribute to a reduction in total weight of the vehicle frame assembly.

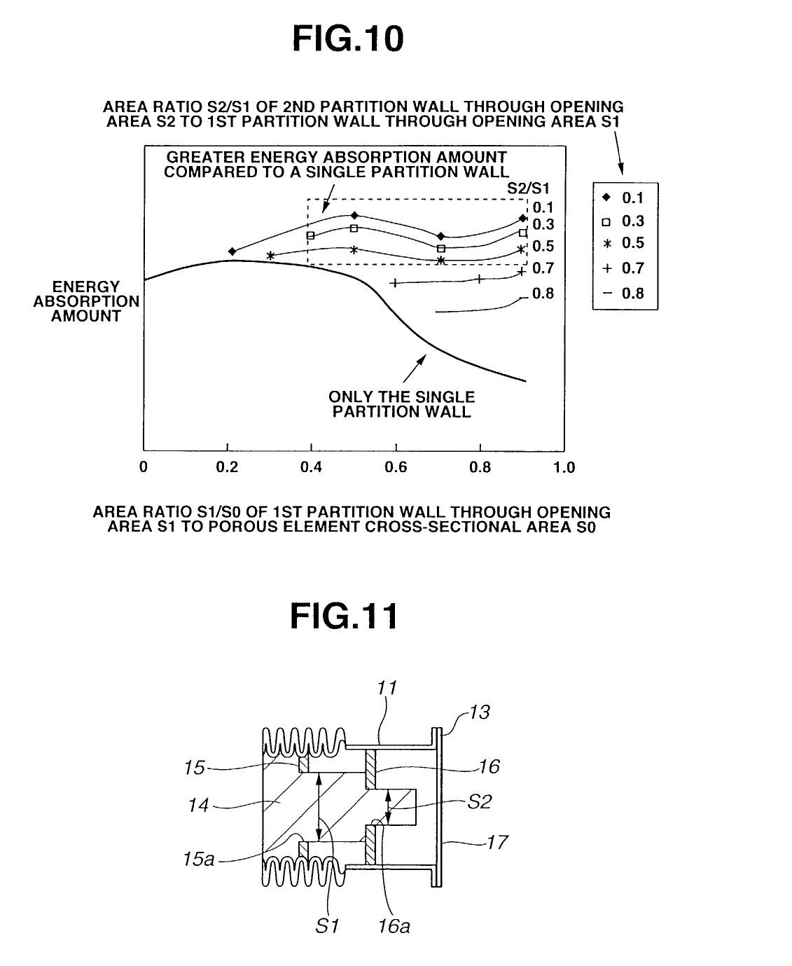

FIG. 10 shows test results illustrating the relationship among the energy absorption amount (energy absorption power), the area ratio S1/S0 of the opening area S1 of first partition wall through opening 15a to the cross-sectional area S0 of porous element 14 (exactly, the area of the initial contact portion of porous element 14 that is brought into initial contact with respect to partition wall 15 just after compressive-load application), and the area ratio S2/S1 of the opening area S2 of second partition wall through opening 16a to opening area S1 of first partition wall through opening 15a. The test results shown in FIG. 10 are experimentally assured by the inventors of the present invention, under a specified condition where the hollow portion of front outer-shell structural member 11 of front side member 10A is filled with a substantially cylindrical porous element 14 (aluminum foam) having a density of 0.3 g/cm³ and an entire axial length (a filling length) of 120 mm, and front outer-shell structural member 11 has a characteristic length of 80 mm in cross section, a thickness of the previously-noted first outer-shell portion of front outer-shell structural member 11 filled with porous element 14 is dimensioned to be 1.4 mm, and an interval between first and second partition walls 15 and 16 is dimensioned to be 60 mm. In a plurality of characteristic curves shown in FIG. 10, the lowermost heavy solid line indicates the energy absorption amount versus area ratio S1/S0 (that is, the area ratio of front side member 10 having only the first partition wall 15) characteristic curve. On the other hand, the fine solid lines above the heavy solid line indicate the energy absorption amount versus area ratio S1/S0 (that is, the area ratio of front side member 10A having both the first and second partition walls 15 and 16) characteristics at five different area ratios S2/S1=0.1, 0.3, 0.5, 0.7, and 0.8. Regarding test results indicated by the fine solid line and relating to front side member 10A with first and second partition walls 15 and 16, the energy absorption amount versus area ratio S1/S0 characteristic curve obtained at S2/S1=0.1 is based on four plots (four experimental data) marked by a rhombus. The energy absorption amount versus area ratio S1/S0 characteristic curve obtained at S2/S1=0.3 is based on four plots (four experimental data) marked by a square. The energy absorption amount versus area ratio S1/S0 characteristic curve obtained at S2/S1=0.5 is based on four plots (four experimental data) marked by an asterisk. The energy absorption amount versus area ratio S1/S0 characteristic curve obtained at S2/S1=0.7 is based on three plots (three experimental data) marked by a plus sign. The energy absorption amount versus area ratio S1/S0 characteristic curve obtained at S2/S1=0.8 is based on two plots (two experimental data) marked by a minus sign. The area ratio S2/S1 of second partition wall through opening area S2 to first partition wall through opening area S1 means an area ratio of second partition wall through opening area S2 to the cross-sectional area of porous element 14 (aluminum foam) that has extruded from first partition-wall through opening 15a. From the test results of FIG. 10, it is possible to establish the fact that the energy absorption amount of front side member 10A with first and second partition walls 15 and 16 becomes greater than that of front side member 10 with only the single partition member 15, when two conditions defined by two inequalities 0.4≦S1/S0≦0.9 and S2/S1≦0.5 (preferably, 0.1≦S2/S1≦0.5) are simultaneously satisfied (see the characteristic curves included in the rectangular area indicated by the broken line in FIG. 10). In the second embodiment, front outer-shell structural member 11, having first and second partition walls 15 and 16 in its hollow portion 11a, is integrally connected to rear outer-shell structural member 12 defining therein a hollow portion by means of flange 13. In lieu thereof, a partition wall 17 no having a through opening is attached to the rearmost end of front outer-shell structural member 11 by means of flange 13. As shown in FIG. 11, partition wall 17 not having any through opening is located at the farthermost position from the application point of compressive stress. In this case, the ratio (0/S0=0) of the through opening area (=0) of partition wall 17 to the area (=S0) of the initial contact portion of porous element 14 that is brought into initial contact with respect to the partition wall is “0”.

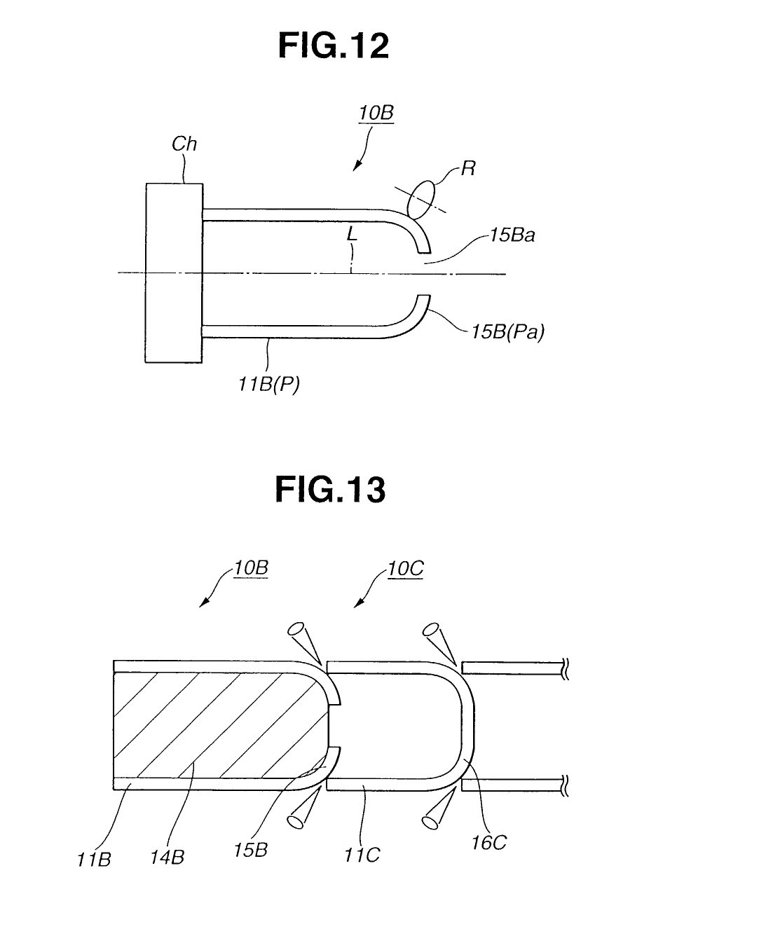

Referring now to FIG. 12, there is shown a forming process of an outer-shell structural member 11B of an impact energy absorbing structural member 10B of the third embodiment. Impact energy absorbing structural member 10B of the third embodiment is formed at one end (at the rearmost end) with a diametrically-diminished partition wall 15b that is diametrically diminished by way of a metal spinning process, when compared to the outside diameter of outer-shell structural member 11B. As a preliminary work for the metal spinning process of outer-shell structural member 11B, a tube material P, such as metal tube, is grasped in a chuck Ch, and then tube material P gasped in the chuck is rotated about its axis L. Thereafter, to form the diametrically-diminished or round-ended partition wall 15B, the metal spinning process is made to the one end Pa of tube material P by means of a work roller R, while heating the one tube end Pa. In the spinning process used in the production of outer-shell structural member 11B with round-ended partition wall 15B, the diameter of tube material P (constructing outer-shell structural member 11B) tends to shrink after the spinning process. As a result of this, the thickness of the round-ended partition wall portion tends to become relatively greater than that of outer-shell structural member 11B. If the spinning process is made to the one end Pa of tube material P in such a manner as to permit the entire length of tube material P to freely extend for the purpose of keeping the thickness of tube material P substantially uniform, such a spinning process contributes to the production of partition wall 15B having a yield stress increased owing to work hardening. The impact energy absorbing structural member of the third embodiment is exemplified in outer-shell structural member 11B with round-ended partition wall 15B formed therein with a through opening 15Ba. That is, the one end Pa is formed as an opening end. To produce partition wall 17 (see FIG. 11) not having a through opening and provided at the farthest position from the application point of compressive stress, the one end Pa of tube material P may be formed as a relatively thick-walled closed section partition wall member by spinning.

Referring now to FIG. 13, there is shown an impact energy absorbing structural member 10C if the fourth embodiment. Impact energy absorbing structural member 10C of the fourth embodiment is produced by welding an outer-shell structural member 11C to round-ended partition wall 15B of outer-shell structural member 11B of impact energy absorbing structural member 10B of the third embodiment of FIG. 12, by way of unidirectional welding such as laser beam welding. Outer-shell structural member 11C is formed at one end with a round-ended partition wall 16c diametrically diminished by spinning. As seen from the cross section of FIG. 13, porous element 14 (metal foam) fills the interior space of outer-shell structural member 11B. Round-ended partition wall 15B of outer-shell structural member 11B is formed therein with the through opening 15Ba, whereas round-ended partition wall 16C of outer-shell structural member 11C is not formed therein with a through opening.

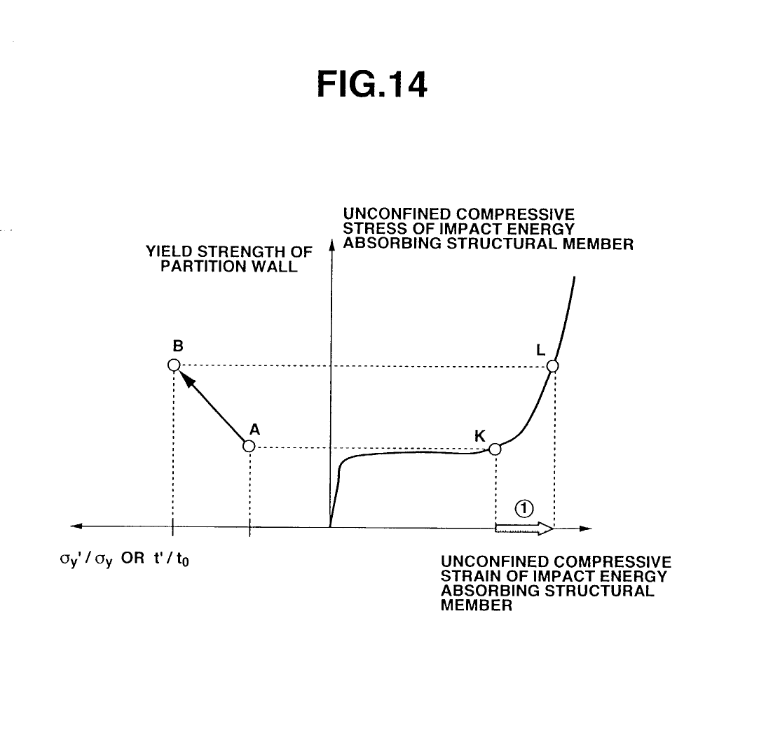

Referring now to FIG. 14, there is shown the relationship among the ratio t′/t₀ of thickness t′ of partition wall 15B formed by metal-spinning as shown in FIG. 12 to thickness t₀ of outer-shell structural member 11B (or the ratio σ_{y}′/σ_{y} of yield stress σ_{y}′ of partition wall 15B formed by metal-spinning to yield stress σ_{y} of outer-shell structural member 11B), and an unconfined compressive strain of the impact energy absorbing structural member (in particular, porous element 14 filling the hollow portion or interior space of outer-shell structural member 11B). From the test results shown in FIG. 14, briefly speaking, it is possible to effectively increase a compressive strain (in other words, the degree of compressive deformation) of the porous element (filling material), in the case that as a result of metal-spinning the thickness t′ of partition wall 15B (or yield stress σ_{y}′ of partition wall 15B) is relatively greater than the thickness t₀ of outer-shell structural member 11B (or yield stress σ_{y} of outer-shell structural member 11B). More concretely, when the thickness t′ of partition wall 15B (or yield stress σ_{y}′ of partition wall 15B) increases from a point A to a point B (see the second quadrant of the coordinate system or the left-hand half of FIG. 14), a yield strength of partition wall 15B in the direction of collapsing deformation of porous element 14B itself, occurring during collapsing deformation of impact energy absorbing structural member 10B, tends to increase from a point K to a point L (see the first quadrant of the coordinate system or the right-hand half of FIG. 14). At point A, the thickness t′ of partition wall 15B (or yield stress σ_{y}′ of partition wall 15B) is equal to the thickness t₀ of outer-shell structural member 11B (or yield stress σ_{y} of outer-shell structural member 11B), that is, t′=t₀ (or σ_{y}′=σ_{y}), in other words, t′/t₀=1 (or σ_{y}′/σ_{y}=1). At point B, the thickness t′ of partition wall 15B (or yield stress σ_{y}′ of partition wall 15B) is greater than the thickness t₀ of outer-shell structural member 11B (or yield stress σ_{y} of outer-shell structural member 11B), that is, t′>t₀ (or σ_{y}′>σ_{y}), in other words, t′/t₀>1 (or σ_{y}′/σ_{y}>1). Thus, it is possible to increase the collapse amount of porous element 14B by a certain unconfined compressive strain indicated by the arrow \mathring{1} in FIG. 14, without plastic deformation of partition wall 15B formed by spinning. Due to the increased collapse amount of porous element 14B, the collapse efficiency of impact energy absorbing structural member 10B is remarkably enhanced. For instance, in the case that tube material P (steel tube) having an outside diameter of 60 mm, a thickness of 1.6 mm, and an initial yield stress of 400 MPa is used and additionally partition wall 15B is formed by spinning in such a manner as to keep the thickness of tube material P substantially uniform (1.6 mm), there is a 10% increase in yield stress at an average strain of 2%. Therefore, in the compressive collapse testing of aluminum foam fills the hollow portion of outer-shell structural member 11B as a crashable porous element and having a density of 0.25 g/cm³ and a plateau stress of 2 MPa, there results in approximately a 20% enhancement in collapse efficiency (see the increase in unconfined compressive strain indicated by the arrow \mathring{1} in FIG. 14). In the case that tube material P (steel tube) having an outside diameter of 60 mm, a thickness of 1.6 mm, and an initial yield stress of 400 MPa is used and additionally partition wall 15B is formed by spinning in such a manner as to assure an 50% increase in thickness of tube material P, there is a 100% increase in yield stress and a 75% enhancement in collapse efficiency of impact energy absorbing structural member 10B.

Furthermore, in the case that a tube material having a heat hardenability (a so-called bake-hard property) is used as a structural material for the outer-shell structural member and the partition wall integrally formed with each other, and additionally the partition wall is formed in such a manner as to keep the thickness of the tube material substantially uniform, there is a 10% increase in yield stress at an average strain of 2%. Moreover, there is an additional 10% increase in yield stress owing to the bake-hardening effect, and thus there is a 75% enhancement in collapse efficiency of the impact energy absorbing structural member. As a consequence, there is a 50% enhancement in collapse efficiency in total.

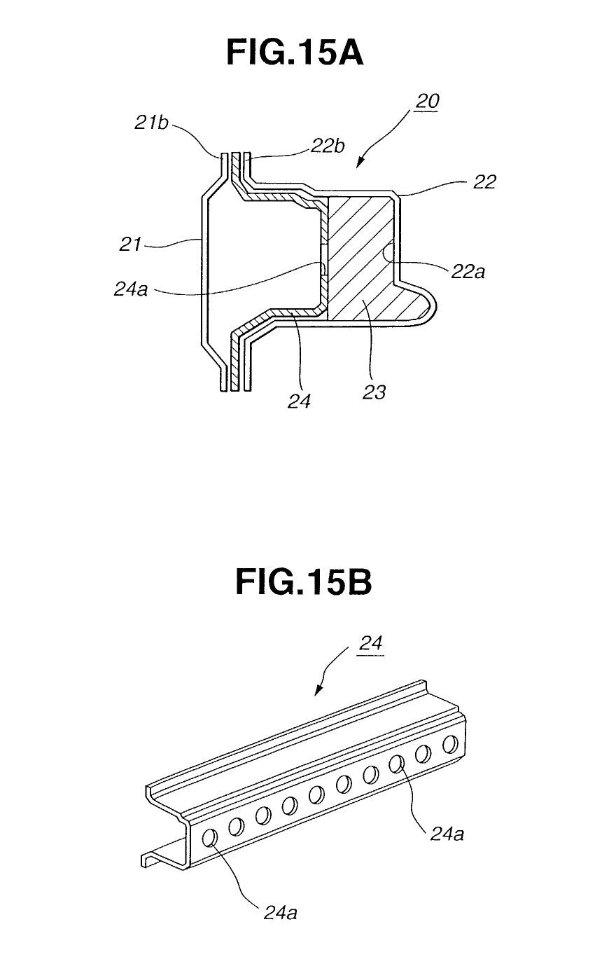

Referring now to FIGS. 15A and 15B, the improved impact energy absorbing structural member of the embodiment is applied to an automotive center pillar 20 (see a portion denoted by reference sign 20 in FIG. 2). Automotive center pillar 20 is mainly subject to a bending stress and/or a bending moment. Center pillar 20 is comprised of a center pillar inner 21, a body side outer 22 (serving as an outer-shell structural member), a porous element 23 (aluminum foam), and a center pillar reinforcement 24 (serving as a partition wall). A hollow portion 22a is defined in body side outer 22. Porous element 23 (aluminum foam) fills hollow portion 22a of body side outer 22 in a manner so as to collapse while keeping a reaction force produced by the porous element constant from an early stage of application of a compressive stress to the center pillar. In center pillar 20 (impact energy absorbing structural member) shown in FIGS. 15A and 15B, center pillar reinforcement 24 (partition wall), formed therein with through openings 24a, is provided in hollow portion 22a of body side outer 22 and located on one side (an inside end face in FIG. 15A) of porous element 23 (filling hollow portion 22a) opposite to the other side (an outside end face in FIG. 15A) of porous element 23 to which the compressive stress is applied. Each of upper and lower flanged portions of center pillar reinforcement 24 (partition wall) is sandwiched and fixedly connected between a flanged portion 21b of center pillar inner 21 and a flanged portion 22b of body side outer 22 by way of welding. Through openings 24a are formed so that the area ratio of a gross area of through openings 24a to an area of the initial contact portion of porous element 23 (aluminum foam) that is brought into initial contact with respect to center pillar reinforcement 24 (partition wall) is within a predetermined range from 0.1 to 0.5. In center pillar 20 (serving as the impact energy absorbing structural member) shown in FIGS. 15A and 15B, when compressive stress is applied from body side outer 22 to the automotive center pillar structural elements in a side-impact situation, body side outer 22 deforms and at the same time porous element 23 (aluminum foam), filling the hollow portion of body side outer 22, compressively deforms for effective impact energy absorption. Additionally, a part of porous element 23 (aluminum foam) extrudes from partition-wall through openings 24a toward the internal space of center pillar inner 21, so as to enhance the impact energy absorption effect.

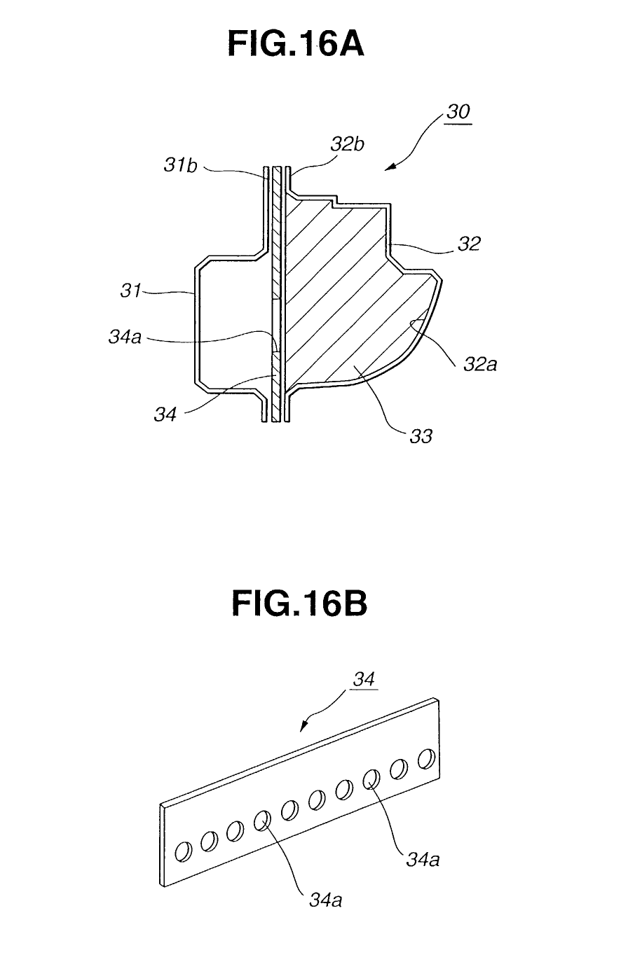

Referring now to FIGS. 16A and 16B, the improved impact energy absorbing structural member of the embodiment is applied to an automotive side sill 30 (see a portion denoted by reference sign 30 in FIG. 2). In a similar manner as center pillar 20, automotive side sill 30 is also subject to a bending stress and/or a bending moment. Side sill 30 is comprised of a sill inner 31, a body side outer 32 (serving as an outer-shell structural member), a porous element 33 (aluminum foam), and a side sill reinforcement 34 (serving as a partition wall). A hollow portion 32a is defined in body side outer 32. Porous element 33 (aluminum foam) fills hollow portion 32a of body side outer 32 in a manner so as to collapse while keeping a reaction force produced by the porous element constant from an early stage of application of a compressive stress to the side sill. In side sill 30 (impact energy absorbing structural member) shown in FIGS. 16A and 16B, sill reinforcement 34 (partition wall), formed therein with through openings 34a, is provided in hollow portion 32a of body side outer 32 and located on one side (an inside end face in FIG. 16A) of porous element 33 (filling hollow portion 32a) opposite to the other side (an outside end face in FIG. 16A) of porous element 33 to which the compressive stress is applied. Each of upper and lower flanged portions of side sill reinforcement 34 (partition wall) is sandwiched and fixedly connected between a flanged portion 31b of sill inner 31 and a flanged portion 32b of body side outer 32 by way of welding. Through openings 34a are formed so that the area ratio of a gross area of through openings 34a to an area of the contact portion of porous element 33 (aluminum foam) that is brought into initial contact with respect to sill reinforcement 34 (partition wall) is within a predetermined range from 0.1 to 0.5. In side sill 30 (serving as the impact energy absorbing structural member) shown in FIGS. 16A and 16B, when compressive stress is applied from body side outer 32 to the automotive side sill structural elements in a side-impact situation, body side outer 32 deforms and at the same time porous element 33 (aluminum foam), filling the hollow portion of body side outer 32, compressively deforms for effective impact energy absorption. Additionally, a part of porous element 33 (aluminum foam) extrudes from partition-wall through openings 34a toward the internal space of sill inner 31, so as to enhance the impact energy absorption effect.

In the shown embodiments, each of through openings (15a; 15Ba; 16a; 24a; 34a) through which part of each of porous elements (14; 14B; 23; 33) extrudes during compressive deformation of the impact energy absorbing structural member in a frontal impact situation or in a side impact situation, is circular in shape. In lieu thereof, each of through openings (15a; 15Ba; 16a; 24a; 34a) may be formed as a rectangular shape or a polygonal shape.

The entire contents of Japanese Patent Application No. P2002-095718 (filed Mar. 29, 2002) is incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. An impact energy absorbing structure comprising:
an outer-shell structural member having a hollow portion;
a porous element filling the hollow portion of the outer-shell structural member and capable of collapsing while keeping a reaction force produced by the porous element constant from a time when a compressive stress is applied to the porous element; and
a partition wall having a through opening formed therein and provided in the hollow portion of the outer-shell structural member and located on one side of the porous element filling the hollow portion, the one side being opposite to the other side to which the compressive stress is applied.

2. The impact energy absorbing structure as claimed in claim 1, wherein:
an area ratio of an opening area of the through opening of the partition wall to a cross-sectional area of the outer-shell structural member sectioned in a plane perpendicular to a neutral axis of the outer-shell structural member is dimensioned to be within a range from 0.1 to 0.5.

3. The impact energy absorbing structure as claimed in claim 1, wherein:
at least one additional partition wall having a through opening formed therein and provided in the hollow portion of the outer-shell structural member and located on one side of the partition wall facing apart from the one side of the porous element.

4. The impact energy absorbing structure as claimed in claim 1, wherein:
an area of an initial contact portion of the porous element filling the hollow portion of the outer-shell structural member that is brought into initial contact with respect to the partition wall after application of the compressive stress is dimensioned to be greater than or equal to a gross area of the through opening of the partition wall.

5. The impact energy absorbing structure as claimed in claim 3, wherein:
an area ratio S1/S0 of an opening area S1 of the through opening of the partition wall to an area S0 of an initial contact portion of the porous element that is brought into initial contact with respect to the partition wall after application of the compressive stress is set to satisfy an inequality 0.4≦S1/S0≦0.9.

6. The impact energy absorbing structure as claimed in claim 3, wherein:
the through opening of the additional partition wall, located at a farthermost position from a point of application of the compressive stress, is closed.

7. The impact energy absorbing structure as claimed in claim 3, wherein:
an area ratio S2/S1 of an opening area S2 of the through opening of the second partition wall spaced apart from the partition wall nearest to a point of application of the compressive stress to an opening area S1 of the through opening of the partition wall nearest to the point of application of the compressive stress is set to satisfy an inequality S2/S1≦0.5.

8. The impact energy absorbing structure as claimed in claim 3, wherein:
an area ratio S2/S1 of an opening area S2 of the through opening of the second partition wall spaced apart from the partition wall nearest to a point of application of the compressive stress to an opening area S1 of the through opening of the partition wall nearest to the point of application of the compressive stress is set to satisfy an inequality 0.1≦S2/S1≦0.5.

9. The impact energy absorbing structure as claimed in claim 1, wherein:
a first outer-shell portion of the outer-shell structural member, which is in contact with the porous element, is easier to collapse and compressively deform than a second outer-shell portion of the outer-shell structural member, which is out of contact with the porous member.

10. The impact energy absorbing structure as claimed in claim 9, wherein:
a thickness of the first outer-shell portion is dimensioned to be relatively thinner than a thickness of the second outer-shell portion.

11. The impact energy absorbing structure as claimed in claim 9, wherein:
a material strength of the first outer-shell portion is set to be relatively weaker than a material strength of the second outer-shell portion.

12. The impact energy absorbing structure as claimed in claim 1, wherein:
the partition wall elastically deforms by a load dissipated in the porous element during application of the compressive stress.

13. The impact energy absorbing structure as claimed in claim 1, wherein:
the partition wall is formed as a diametrically-diminished section by diametrically diminishing one end of the outer-shell structural member.

14. The impact energy absorbing structure as claimed in claim 13, wherein:
the diametrically-diminished section is formed by spinning.

15. The impact energy absorbing structure as claimed in claim 1, wherein:
a thickness of the partition wall is dimensioned to be relatively thicker than a thickness of the outer-shell structural member.

16. The impact energy absorbing structure as claimed in claim 1, wherein:
a material strength of the partition wall is set to be relatively stronger than a material strength of the outer-shell structural member.

17. The impact energy absorbing structure as claimed in claim 1, wherein:
the partition wall is formed of a material having a heat hardenability.

18. The impact energy absorbing structure as claimed in claim 1, wherein:
the through opening of the partition wall is formed as a frusto-conical tapered through opening, and an inner peripheral wall surface of the frusto-conical tapered through opening is inclined by a predetermined inclination angle with respect to a wall surface of the partition wall facing apart from the porous element filling the hollow portion; and
the inclination angle is selected from an angular range including angles substantially corresponding to 90° and angles less than or equal to 40°.

19. The impact energy absorbing structure as claimed in claim 1, wherein:
the porous element is made of metal foam.

20. The impact energy absorbing structure as claimed in claim 1, wherein:
the outer-shell structural member, the porous element, and the partition wall are automotive structural elements.
